(19) United States
(12) Patent Application Publication
(10) Pub. No.: US 2013/0205354 A1
(43) Pub. Date: Aug. 8, 2013

(54) VCR CONTROL CAPABILITIES FOR INFORMATION PLAY SESSIONS

(71) Applicants: Jayakumar Balaji, Guindy (IN); Balasubramanian Gopalasubramanian, Guindy (IN); Ramachandran Gopannan, Guindy (IN)

(72) Inventors: Jayakumar Balaji, Guindy (IN); Balasubramanian Gopalasubramanian, Guindy (IN); Ramachandran Gopannan, Guindy (IN)

(73) Assignee: ALCATEL LUCENT, Paris (FR)

(21) Appl. No.: 13/697,638

(22) PCT Filed: Sep. 7, 2010
(86) PCT No.: PCT/EP2010/063072

§ 371 Date: Apr. 5, 2013

(30) Foreign Application Priority Data
Jun. 22, 2010 (IN) 1746/CHE/2010

(51) Int. Cl. H04N 21/472

(52) U.S. Cl. CPC H04N 21/47217
USPC 725/88

(57) ABSTRACT

The present invention relates to communication networks and, more particularly, to information playback in communication networks. System and method for enabling Video Cassette Recording controls while information is being played to a user. A Media Gateway Controller indicates to a Media Server that the user could exercise Video Cassette Recording controls on the information while the information is being played to the user. The Media Server plays the information to the user and receives a Video Cassette Recording control command entered by the user. The Media Server performs an action on the information according to the Video Cassette Recording control command. The user is an Intelligent Network Application Part (INAP)/Customized Applications for Mobile networks Enhanced Logic (CAMEL) user.

The following specification particularly describes and ascertains the nature of this invention and the manner in which it is to be performed:

### TECHNICAL FIELD

The present invention relates to communication networks and, more particularly, to information playback in communication networks.

### BACKGROUND

In communication networks a user may receive different types of information from the network. The information may be a prompt announcement made by the network to the user or the information may be any information requested by the user. The information may be played to the user as a text message, audio message or a video message. Typically in networks employing Intelligent Network Application Part (INAP)/Customized Applications for Mobile networks Enhanced Logic (CAMEL), the user gets one opportunity to listen/view the information being played and the user has no control over the flow of information. In such a scenario, if the user fails to grasp any portion of the information, then the user may not be able to view/listen to the portion of information missed by the user. The user may have to go through the entire process of requesting for the information from the network and then view/listen to the entire message in order to obtain the portion of the information that was missed by the user. In some cases the process of requesting for the information from the network, a second time, may incur additional costs to the user.

For example, if the user requests for video on demand service and the user misses a part of the video while the video is being played, then the user would not be able to view the missed part. To view the missed part the user may have to request for the same video once again after paying any fee applicable for playing the video. In a second example, if a prompt announcement, “Enter the password”, is being played to the user and the user fails to hear the prompt announcement, then the user would not know what is to be entered. The user would not be able to play the prompt announcement once again without starting the communication session with the network from the initial phase.

### SUMMARY

In view of the foregoing, an embodiment herein provides a method for enabling Video Cassette Recording controls while information is being played to a user. A Media Server plays the information to the user and receives a Video Cassette Recording control command entered by the user. The Media Server performs an action on the information according to the Video Cassette Recording control command. The user is an Intelligent Network Application Part (INAP)/Customized Applications for Mobile networks Enhanced Logic (CAMEL) user. A Service Control Point sends the Video Cassette Recording control options to a Media Gateway Controller, the Media Gateway Controller indicates to the Media Server that the user could exercise Video Cassette Recording controls on the information while the information is being played to the user and the Media Gateway Controller sends the Video Cassette Recording control options to the Media Server. The Service Control Point sends the Video Cassette Recording control options in at least one of a Play Announcement, a Prompt and Collect User Information and Prompt and Receive Message. The Media Gateway Controller sends the Video Cassette Recording control options to the Media Server in a Session Initiation Protocol (SIP) INFO message using Media Server Markup Language (MSML) format. The information is at least one of a text message, an audio file, a video file or a prompt announcement. The Media Server is in a send-receive mode when the information is being played to the user. The Video Cassette Recording controls are at least one of Gotostart, Gotoend, Fastforward, Rewind, Pause, Resume, Volumeup, Volumedown, Speedup, Speeddown, Volumeinterval, Speedinterval and Pauseinterval.

Embodiments further disclose a Media Gateway Controller for enabling Video Cassette Recording controls while information is being played to a user. The Media Gateway Controller indicates to a Media Server that the user could exercise Video Cassette Recording controls on the information while the information is being played to the user. The Media Gateway Controller receives the Video Cassette Recording control options from a Service Control Point. The Media Gateway Controller sends the Video Cassette Recording control options to the Media Server in a Session Initiation Protocol (SIP) INFO message using Media Server Markup Language (MSML) format. The user is an Intelligent Network Application Part (INAP)/Customized Applications for Mobile networks Enhanced Logic (CAMEL) user.

Embodiments herein also disclose a Media Server for enabling Video Cassette Recording controls while information is being played to a user. The Media Server receives an indication from a Media Gateway Controller that the user could exercise Video Cassette Recording controls on the information while the information is being played to the user. The Media Server plays the information to the user, receives the Video Cassette Recording control command entered by the user and performs an action on the information according to the Video Cassette Recording control command. The user is an Intelligent Network Application Part (INAP)/Customized Applications for Mobile networks Enhanced Logic (CAMEL) user.

Also, disclosed herein is a system for enabling Video Cassette Recording controls while information is being played to a user. The system plays the information to the user and receives a Video Cassette Recording control command entered by the user. The system performs an action on the information according to the Video Cassette Recording control command. The user is an Intelligent Network Application Part (INAP)/Customized Applications for Mobile networks Enhanced Logic (CAMEL) user. The system receives the Video Cassette Recording control options from a Service Control Point and indicates that the user could exercise Video Cassette Recording controls on the information while the information is being played to the user. The Service Control Point sends the Video Cassette Recording control options in at least one of a Play Announcement, a Prompt and Collect User Information and Prompt and Receive Message. The information is at least one of a text message, an audio file, a video file or a prompt announcement. The system is in a send-receive mode when the information is being played to the user. The Video Cassette Recording controls are at least one of Gotostart, Gotoend, Fastforward, Rewind, Pause, Resume, Volumeup, Volumedown, Speedup, Speeddown, Volumeinterval, Speedinterval and Pauseinterval.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of a user in a communication network, according to an embodiment herein;

FIG. 2 is a block diagram of a Media Gateway Controller (MGC), according to an embodiment herein;

FIG. 3 is a block diagram of a Media Server (MS), according to an embodiment herein.

FIG. 4 is a flowchart depicting a method for enabling VCR controls when information is being played, according to an embodiment herein;

FIG. 5 illustrates a flow diagram for an example illustrating use of VCR controls when information is being played, according to an embodiment herein;

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

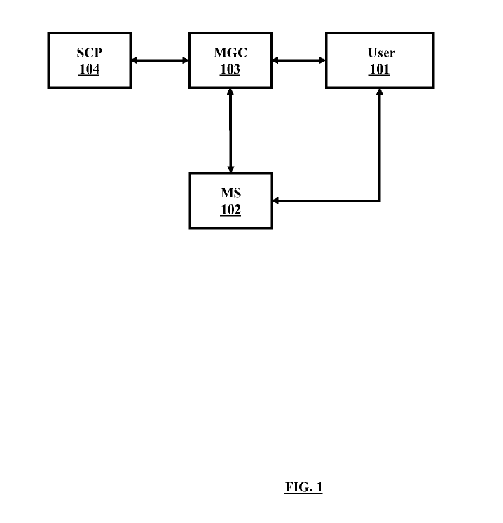

The embodiments herein disclose system and method for enabling Video Cassette Recording (VCR) controls while information is being played to an Intelligent Network Application Part (INAP)/Customized Applications for Mobile networks Enhanced Logic (CAMEL) user. The information may be played in the form of text, audio or video messages or a combination of text, audio or video messages. Referring now to the drawings, and more particularly to FIGS. 1 through 4, where similar reference characters denote corresponding features consistently throughout the figures, there are shown embodiments.

FIG. 1 illustrates a block diagram of a user in a communication network. In a communication network, a user 101 may receive different types of information from a Media Server (MS) 102. The user 101 referred to herein is an INAP/CAMEL user. For example, the information may be in the form of a prompt announcement, an audio message, music, video or a combination of audio, text and/or video. The user 101 may receive an announcement saying “Enter the password”. The user 101 can exercise VCR controls on the information that is being played to the user 101. For example, the user 101 can forward, rewind, pause, stop the information that is being played and the control options being exercised by the user 101 are the VCR controls.

The MS 102 is a server that helps establish and maintain a multi media session with the INAP/CAMEL user 101. The MS 102 also stores media and shares the stored media with users of the network. Before the user 101 can start receiving information from the MS 102, the user 101 initiates a communication link with the network. The user 101 may initiate the communication link by sending a request to a Media Gateway Controller (MGC) 103. The MGC 103 receives signaling information from the MS 102 and instructs the MS 102 to alert the destination in order to start a communication session between the calling user and the destination. The destination may be a second user in the communication network with whom the calling user wishes to communicate. The MGC 103 also acts as a Service Switching Point (SSP) and makes available additional services during a communication session. In other embodiments, the SSP may be a network element located outside the MGC 103.

On receiving the request from the INAP/CAMEL user 101 and on determining that some information may be transferred between the user 101 and the communication network, the MGC 103 triggers a Service Control Point (SCP) 104. The SCP 104 is used to help control the services offered by the network. The SCP 104 identifies the number to which a communication session is to be routed and then routes the communication session to the number. The SCP 104 also helps in playing the information to the user 101. The SCP 104 contains the service logic that implements the services related to transfer of information between the user 101 and the communication network. On being triggered, the SCP 104 instructs the MS 102, using the MGC 103, to start a communication session with the user 101. When information has to be transferred between the user 101 and the network, the SCP 104 sends the information that is to be played to the user 101 to the MS 102 and instructs the MS 102 that the MS 102 may also have to receive information from the user 101. The SCP 104 also sends an ID indicating the information to be played to user 101. For example, the SCP 104 may send a Prompt and Collect User Information (PACUI), Play Announcement (PA) or a Prompt and Receive Message (PARM) to the MS 102. The PACUI is used to play a prompt announcement and collect digits from the user 101. PA is used to play any announcement to the user 101 and the PARM is used to play a prompt announcement and record a message received from the user 101. The prompt announcement made to the user 101 may be “Enter the user ID” or a music file may be played to the INAP/CAMEL user 101.

The MGC 103 instructs the MS 102 that the user 101 can exercise VCR controls on the information that is being played to the user 101. When the MS 102 determines that the user 101 could exercise VCR controls on the information, the MS 102 will be in a send-receive mode with the user 101 in order to play the information to the user 101 and at the same time being able to receive any control command from the user 101. The MS 102 may also convey the control options to the user 101. For example, the MS 102 may inform the user 101 that the control option to forward the information is #1, which can be entered using a communication terminal. If the user 101 wants to forward the information being played, then the user 101 enters #1 using the communication terminal. The controls options may be conveyed to the user 101 when the user 101 subscribes to the communication network or the controls options may be conveyed to the user 101 during each communication session. The controls options may be any single key or a combination of multiple keys on the communication terminal and the control options may be sent from the communication to the MS 102 using Dual Tone Multi Frequency (DTMF) signaling. Information transfer between the MS 102 and the user 101 may happen through Real-time Transport Protocol (RTP).

Some examples, of the VCR control commands that can be exercised by the user 101 are as follows
a) Gotostart: skip directly to the start of the information.
b) Gotoend: skip directly to the end of the information.
c) Fastforward: fast forward the information being played.
d) Rewind: rewind the information being played.
e) Pause: pause the information being played.
f) Resume: resume playing the information.
g) Volumeup: increase the volume of the information being played.
h) Volumedown: decrease the volume of the information being played.
i) Speedup: increase the speed of the information being played.
j) Speeddown: decrease the speed of the information being played.
k) Volumeinterval: increase or decrease volume of information being played when volumeup or volumedown option is entered. A volumeinterval may be expressed as a percentage.
l) Speedinterval: increase or decrease speed of information being played when fastforward or rewind option is entered. A speedinterval may be expressed as a percentage.
m) Pauseinterval: indicates how long the information has to be paused when the pause option is entered. A pauseinterval value may be expressed in time units.

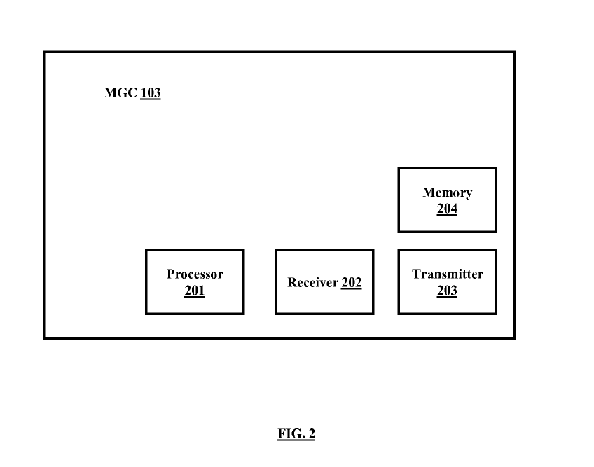

FIG. 2 is a block diagram of a Media Gateway Controller (MGC). In a communication network, a user 101 may receive different types of information from the MS 102. Before the user 101 can start receiving information from the MS 102, the user 101 initiates a communication link with the network. The user 101 may initiate the communication link by sending a request to a Media Gateway Controller (MGC) 103. The MGC 103 receives the request through a receiver 202. On receiving the request from the user 101, and on determining that information may be transferred between the user 101 and the communication network, the MGC 103 triggers the SCP 104. On being triggered, the SCP 104 instructs the MS 102, using the MGC 103, to start a communication session with the SIP user 101. When information is to be received from the user 101, the SCP 104 sends an announcement to the MS 102, through the MGC 103, and instructs the MS 102 that information may have to be received from the user 101. The announcement sent by the SCP 104 is to be played to the user 101. The SCP 104 also sends the control options to the MGC 103. For example, the announcement may be any information to be played to the user 101, a control option may be as enter #5 for pausing the announcement, the information received from the user 101 would be a control command and the SCP 104 may send the message to the MGC 103 as a PA. The SCP 104 also sends an announcement ID indicating the announcement to be played to the user 101.

On receiving the announcement ID from the SCP 104, the MGC 103 maps the announcement ID to the corresponding Uniform Resource Locator (URL) of the announcement. The URL indicates the location of the announcement in the MS 102. For example, URL of the announcement received may be “file:/loc1/PROMPT1.wav”. The MGC 103 receives the announcement ID from the SCP 104, determines the location of the announcement in the MS 102 and maps the announcement ID to the corresponding URL of the announcement. A processor 201 controls the functioning of the MGC 103. All the actions performed by the MGC 103 are coordinated by the processor 201. The processor 201 maps the announcement ID to the URL of the announcement. The URL of a corresponding announcement ID may be stored in a memory 204. The MGC 103 sends the URL of the announcement to the MS 102 through a transmitter 203. For example, the MGC 103 may send the URL of the announcement in a Session Initiation Protocol (SIP) INFO message using Media Server Markup Language (MSML)/Media Server Control Interactive Voice Response (MSCIVR) format.

The MGC 103 informs the MS 102 that the user 101 can exercise VCR controls on the information that is being played to the user 101. The MGC 103 also sends the control options to the MS 102. For example, the MGC 103 may send the control options and the instruction to the MS 102 that the user 101 can exercise VCR controls in a Session Initiation Protocol (SIP) INFO message using Media Server Markup Language (MSML)/Media Server Control Interactive Voice Response (MSCIVR) format. When the MS 102 determines that the user 101 could exercise VCR controls on the information, the MS 102 will be in a send-receive mode with the user 101.

On receiving the message from the MGC 103, the MS 102 locates the announcement using the URL of the announcement and plays the announcement to the user 101. The MS 102 may also convey the control options to the user 101. For example, if the URL of the announcement received from the MGC 103 is “file:/loc1/ANN1.wav” and the location indicated by the URL has a music file, then the MS plays the music to the user 101. When the announcement is being played to the user 101, the user 101 can exercise any VCR control command to control the flow of information. The MS 102 receives and processes the control command while simultaneously playing the announcement to the user 101. For example, while music is being played to the user 101, the user 101 may choose to forward the music by entering #3. The announcement is played to the user 101 through a communication terminal and the user 101 enters the VCR control command using the communication terminal.

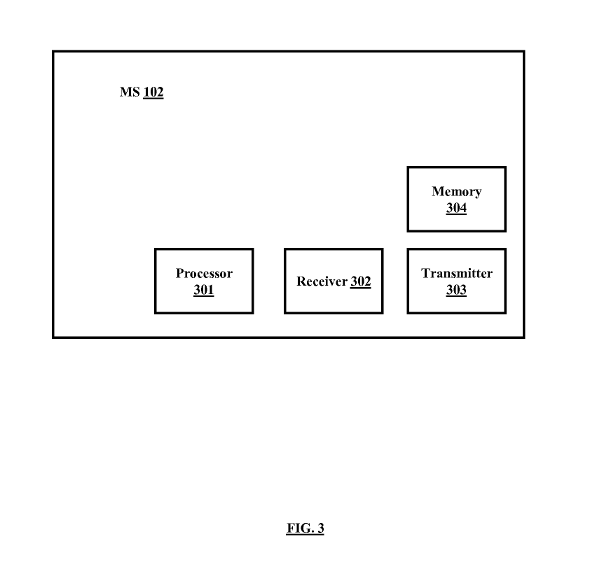

FIG. 3 is a block diagram of a Media Server (MS). In a communication network, a user 101 may receive different types of information from the MS 102. Before the user 101 can start receiving information from the MS 102, the user 101 initiates a communication link with the network. The user 101 may initiate the communication link by sending a request to a Media Gateway Controller (MGC) 103. On receiving the request from the user 101, and on determining that information may be transferred between the user 101 and the communication network, the MGC 103 triggers the SCP 104. On being triggered, the SCP 104 instructs the MS 102, using the MGC 103, to start a communication session with the SIP user 101. When information is to be received from the user 101, the SCP 104 sends an announcement to the MS 102, through the MGC 103, and instructs the MS 102 that information may have to be received from the user 101. The announcement sent by the SCP 104 is to be played to the user 101. The SCP 104 also sends the control options to the MGC 103. The SCP 104 also sends an announcement ID indicating the announcement to be played to the user 101.

On receiving the announcement ID from the SCP 104, the MGC 103 maps the announcement ID to the corresponding Uniform Resource Locator (URL) of the announcement. The URL indicates the location of the announcement in the MS 102. The MGC 103 receives the announcement ID from the SCP 104, determines the location of the announcement in the MS 102 and maps the announcement ID to the corresponding URL of the announcement. The MGC 103 sends the URL of the announcement to the MS 102. The MGC 103 informs the MS 102 that the user 101 can exercise VCR controls on the information that is being played to the user 101. The MGC 103 also sends the control options to the MS 102.

The MS 102 receives messages from the MGC 103 and the user 101 through a receiver 302. When the MS 102 determines that the user 101 could exercise VCR controls on the information, the MS 102 will be in a send-receive mode with the user 101. On receiving the message from the MGC 103, the MS 102 locates the announcement using the URL of the announcement. A processor 301 controls the functioning of the MS 102. All the actions performed by the MS 102 are coordinated by the processor 301. The processor 301 locates the announcement using the URL of the announcement. The announcement corresponding to the URL may be stored in a memory 304. On locating the announcement, the MS 102 plays the announcement to the user 101. The MS 102 may also convey the control options to the user 101. The MS 102 sends messages to the user 101 through a transmitter 303. When the announcement is being played to the user 101, the user 101 can exercise any VCR control command to control the flow of information. The MS 102 receives and processes the control command while simultaneously playing the announcement to the user 101.

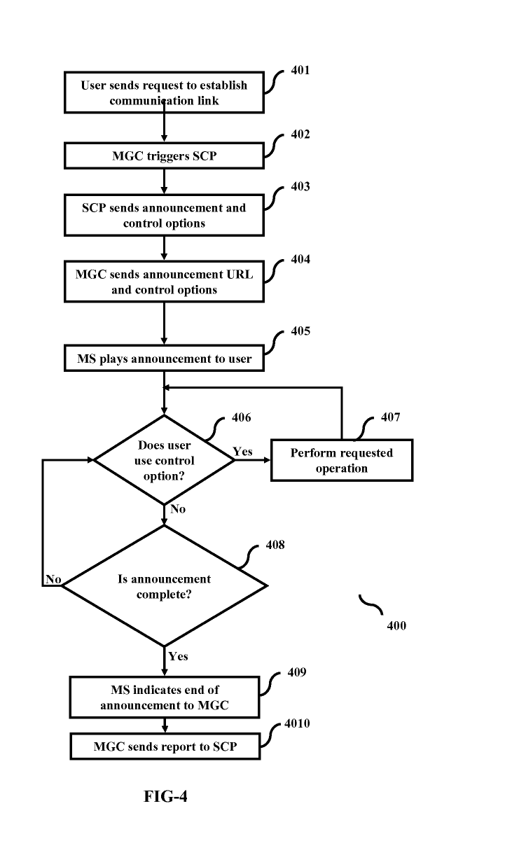

FIG. 4 is a flowchart depicting a method for enabling VCR controls when information is being played. In a communication network, a user 101 may receive different types of information from a MS 102. Before the user 101 can start receiving information from the MS 102, the user 101 initiates (401) a communication link with the network. The user 101 may initiate the communication link by sending a request to the MGC 103. On receiving the request from the INAP/CAMEL user 101, and on determining that information may be transferred between the user 101 and the communication network, the MGC 103 triggers (402) the SCP 104. On being triggered, the SCP 104 instructs the MS 102, using the MGC 103, to start a communication session with the SIP user 101. When information is to be received from the user 101, the SCP 104 sends (403) an announcement to the MS 102, through the MGC 103, and instructs the MS 102 that information may have to be received from the user 101. The announcement sent by the SCP 104 is to be played to the user 101. The SCP 104 also sends the control options to the MGC 103. On receiving the announcement ID from the SCP 104, the MGC 103 maps the announcement ID to the corresponding URL of the announcement and sends (404) the URL of the announcement and the control options to the MS 102. The MGC 103 also informs the MS 102 that the user 101 can exercise VCR controls, provided by SCP 104, on the information that is being played to the user 101. On receiving the message from the MGC 103, the MS 102 locates the announcement using the URL of the announcement and plays (405) the announcement to the user 101. When the announcement is being played to the user 101, the user 101 can exercise any VCR control command to control the flow of information. The MS 102 receives and processes the control command while simultaneously playing the announcement to the user 101. If the user 101 exercises (406) any control option, then the MS 102 performs (407) the operation requested by the user 101. If the announcement is complete (408), then the MS 102 sends (409) an indication to the MGC 103 indicating that the end of the announcement. On receiving the end of announcement indication from the MS 102, the MGC sends (4010) a report to the SCP 104 to indicate the end of the announcement. The various actions in method 400 may be performed in the order presented, in a different order or simultaneously. Further, in some embodiments, some actions listed in FIG. 4 may be omitted.

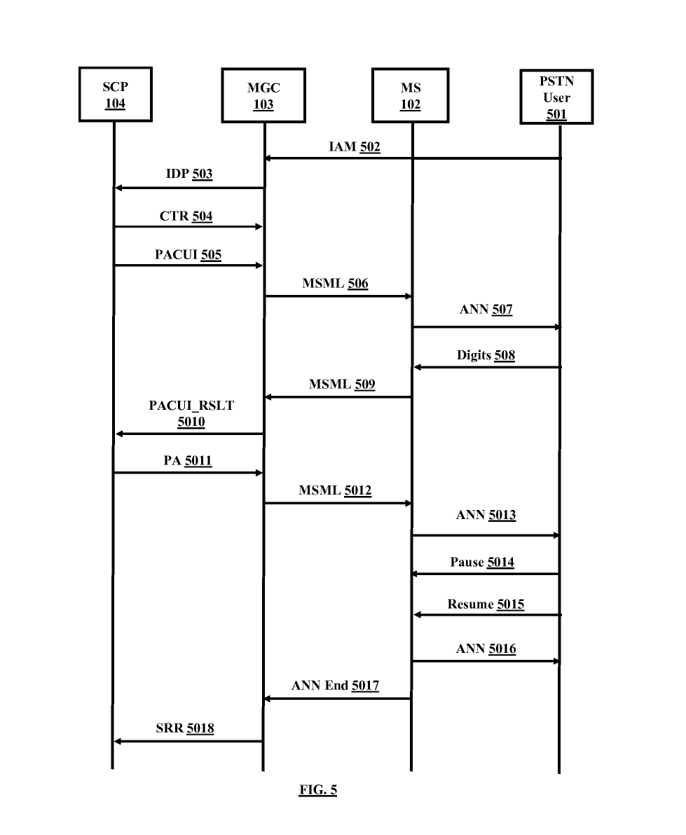

FIG. 5 illustrates a flow diagram for an example illustrating use of VCR controls when information is being played. In a communication network, a user 101 may receive different types of information from a MS 102. In this example, the user 101 is a PSTN user 501. Before the PSTN user 501 can start receiving information from the MS 102, the PSTN user 501 initiates a communication link with the network. The PSTN user 501 may initiate the communication link by sending a request to the MGC 103. The initial message sent by the PSTN user 501 to the MGC 103 may be an Initial Address Message (IAM) 502. The PSTN user 501 may also send the service code number of the service required by the PSTN user 501. If the PSTN user 501 wants to avail of the audio on demand service, then the PSTN user 501 sends the service code 800 along with the IAM 502. On receiving the request from the PSTN user 501, and on determining that information may be transferred between the PSTN user 501 and the communication network, the MGC 103 triggers the SCP 104. The MGC 103 may trigger the SCP 104 by sending an Initial Detection Point (IDP) 503 to the SCP 104. On being triggered, the SCP 104 instructs the MS 102, using the MGC 103, to start a communication session with the SIP user 101. The SCP 104 sends a message to the MS 102, through the MGC 103, to instruct the MS 102. The SCP 104 may send a Connect to Resource (CTR) 504 message to the MGC 103 and the MGC 103 may send an invitation message to the MS 102. The MS 102 then establishes a communication session with the PSTN user 501.

From the service code number entered by the PSTN user 501, the SCP 104 determines that the PSTN user 501 has requested for the audio on demand service. The SCP 104 sends a PACUI 505 to the MGC 103 in order to play a prompt announcement to the PSTN user 501 and determine the exact audio required by the PSTN user 501. The SCP 104 also sends the control options in the PACUI 505. The prompt announcement to be made to the PSTN user 501 may be as “Enter the code of the audio” and the PACUI 505 contains the ID of the prompt announcement. On receiving the prompt announcement ID from the SCP 104, the MGC 103 maps the prompt announcement ID to the corresponding URL of the announcement and sends the URL to the MS 102. The MGC 103 may send the URL as a SIP info message in MSML 506 format. The MGC 103 also informs the MS 102 that the PSTN user 501 can exercise VCR controls on the information that is being played to the PSTN user 501 and the MGC 103 sends the control options to the MS 102 in the MSML 506 message. On receiving the message from the MGC 103, the MS 102 locates the announcement using the URL of the announcement and plays the announcement to the PSTN user 501. The announcement may be played as an ANN 507 message and the announcement may be played to the PSTN user 501 through a Real-time Transport Protocol (RTP) connection between the PSTN user 501 and the MS 102. When the announcement is being played to the PSTN user 501, the PSTN user 501 can exercise any VCR control command to control the flow of information. Once the announcement is over, the PSTN user 501 enters the code/ID of the required audio. The PSTN user 501 may enter the code/ID of the required audio as Digits 508. The MS 102 then sends the code/ID of the required audio to the MGC 103. The MS 102 may send the code/ID as a SIP info message in MSML 509 message. The MGC 103 then sends the collected digits to the SCP 104 as a PACUI_RSLT 5010 message.

On determining the code/ID of the required audio message, the SCP 104 sends the ID of the audio file along with the VCR control options to the MGC 103. The SCP 104 may send the ID of the audio file and the VCR control options to the MGC 103 as a PA 5011 message. On receiving the ID of the audio file from the SCP 104, the MGC 103 maps the ID to the corresponding URL of the audio file and sends the URL to the MS 102. The MGC 103 may send the URL as a SIP info message in MSML 5012 format. The MGC 103 also sends the control options to the MS 102 in the MSML 5012 message. On receiving the message from the MGC 103, the MS 102 locates the audio file using the URL of the audio file and plays the audio file to the PSTN user 501. The audio file may be played as an ANN 5013 message and the audio file may be played to the PSTN user 501 through a RTP connection between the PSTN user 501 and the MS 102. When the announcement is being played to the PSTN user 501, the PSTN user 501 can exercise any VCR control command to control the flow of information. If the PSTN user 501 wishes to pause the audio being played then the PSTN user 501 may enter #7 to pause the audio message. The PSTN user 501 may send the instruction to pause the audio as a Pause 5014 message. On receiving the instruction to pause the audio, the MS 102 stops playing the audio file. After a desired interval of time, the PSTN user 501 can decide to continue play of the audio. The PSTN user 501 may enter #8 to continue play of the audio and the instruction to continue play of the audio. The PSTN user 501 may send the instruction to continue play of the audio as a Resume 5015 message. On receiving the instruction to continue playing the audio, the MS 102 resumes playing the audio file. The audio file may be played as an ANN 5016 message. Once the playing of the audio file is complete, the MS 102 sends a message to the MGC 103 indicating the completion of audio file playback. The MS 102 may send an ANN End 5017 message to the MGC 103 to indicate the completion of audio file playback. The MGC 103 then sends a message to the SCP 104 to inform the SCP 104 of the successful completion of audio file playback to the PSTN user 501. The MGC 103 may send a Specialized Resource Report (SRR) 5018 message to the SCP 104 to inform the SCP 104 of the successful completion of audio file playback to the PSTN user 501.

The embodiments disclosed herein can be implemented through at least one software program running on at least one hardware device and performing network management functions to control the network elements. The network elements shown in FIG. 1, FIG. 2 and FIG. 3 include blocks which can be at least one of a hardware device, or a combination of hardware device and software module.

The embodiment disclosed herein specifies system and method for enabling VCR controls while information is being played to an INAP/CAMEL user. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another coding language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented in pure hardware or partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

1. A method for enabling Video Cassette Recording controls while information is being played to a user, the method comprising:
a Media Server playing said information to said user;
said Media Server receiving a Video Cassette Recording control command entered by said user; and
said Media Server performing an action on said information according to said Video Cassette Recording control command.

2. The method, as claimed in claim 1, wherein said user is an Intelligent Network Application Part (INAP)/Customized Applications for Mobile networks Enhanced Logic (CAMEL) user.

3. The method, as claimed in claim 1, wherein said method further comprises:
a Service Control Point sending Video Cassette Recording control options to a Media Gateway Controller; said Media Gateway Controller indicating to said Media Server that said user could exercise Video Cassette Recording controls on said information while said information is being played to said user; and
said Media Gateway Controller sending said Video Cassette Recording control options to said Media Server.

4. The method, as claimed in claim 3, wherein said Service Control Point sends said Video Cassette Recording control options in at least one of:
a Play Announcement;
a Prompt and Collect User Information; and
Prompt and Receive Message.

5. The method, as claimed in claim 3, wherein said Media Gateway Controller sends said Video Cassette Recording control options to said Media Server in a Session Initiation Protocol (SIP) INFO message using Media Server Markup Language (MSML) format.

6. The method, as claimed in claim 1, wherein said information is at least one of:
a text message;
an audio file;
a video file; and
a prompt announcement.

7. The method, as claimed in claim 1, wherein said Media Server is in a send-receive mode when said information is being played to said user.

8. The method, as claimed in claim 1, wherein said Video Cassette Recording control is one of:
Gotostart;
Gotoend;
Fastforward;
Rewind;
Pause;
Resume;
Volumeup;
Volumedown;
Speedup;
Speeddown;
Volumeinterval;
Speedinterval; and
Pauseinterval.

9. A Media Gateway Controller for enabling Video Cassette Recording controls while information is being played to a user, said Media Gateway Controller configured to indicate to a Media Server that said user could exercise Video Cassette Recording controls on said information while said information is being played to said user.

10. The Media Gateway Controller, as claimed in claim 9, wherein said Media Gateway Controller is configured to receive Video Cassette Recording control options from a Service Control Point.

11. The Media Gateway Controller, as claimed in claim 9, wherein said Media Gateway Controller is configured to send said Video Cassette Recording control options to said Media Server in a Session Initiation Protocol (SIP) INFO message using Media Server Markup Language (MSML) format.

12. The Media Gateway Controller, as claimed in claim 9, wherein said user is an Intelligent Network Application Part (INAP)/Customized Applications for Mobile networks Enhanced Logic (CAMEL) user.

13. A Media Server for enabling Video Cassette Recording controls while information is being played to a user, said Media Server configured to,
play said information to said user;
receive said Video Cassette Recording control command entered by said user; and
perform an action on said information according to said Video Cassette Recording control command.

14. The Media Server, as claimed in claim 13, wherein said user is an Intelligent Network Application Part (INAP)/Customized Applications for Mobile networks Enhanced Logic (CAMEL) user.

15. The Media Server, as claimed in claim 13, wherein said media server is configured to receive an indication from a Media Gateway Controller that said user could exercise Video Cassette Recording controls on said information while said information is being played to said user.

16. A system for enabling Video Cassette Recording controls while information is being played to a user, said system configured to,
play said information to said user;
receive a Video Cassette Recording control command entered by said user; and
perform an action on said information according to said Video Cassette Recording control command.

17. The system, as claimed in claim 16, wherein said user is an Intelligent Network Application Part (INAP)/Customized Applications for Mobile networks Enhanced Logic (CAMEL) user.

18. The system, as claimed in claim 16, wherein said system is further configured to:
receive Video Cassette Recording control options from a Service Control Point; and
indicate that said user could exercise Video Cassette Recording controls on said information while said information is being played to said user.

19. The system, as claimed in claim 18, wherein said Service Control Point sends said Video Cassette Recording control options in at least one of:
a Play Announcement:
a Prompt and Collect User Information; and
Prompt and Receive Message.

20. The system, as claimed in claim 16, wherein said information is at least one of:
a text message;
an audio file;
a video file; and
a prompt announcement.

21. The system, as claimed in claim 16, wherein said system is configured to be in a send-receive mode when said information is being played to said user.

22. The system, as claimed in claim 16, wherein said Video Cassette Recording control is one of:
Gotostart;
Gotoend;
Fastforward;
Rewind;
Pause;
Resume;
Volumeup;
Volumedown;
Speedup;
Speeddown;
Volumeinterval;
Speedinterval; and
Pauseinterval.
